(19) United States
(12) Patent Application Publication
(10) Pub. No.: US 2025/0210223 A1
(43) Pub. Date: Jun. 26, 2025

(54) WIRE HARNESS ASSEMBLY

(71) Applicant: Yazaki Corporation, Tokyo (JP)

(72) Inventor: Yukio NISHIO, Shizuoka (JP)

(73) Assignee: Yazaki Corporation, Tokyo (JP)

(21) Appl. No.: 18/976,980

(22) Filed: Dec. 11, 2024

(30) Foreign Application Priority Data
Dec. 20, 2023 (JP) 2023-215083

(51) Int. Cl. H01B 7/00; B60R 16/02

(52) U.S. Cl. CPC H01B 7/0045; B60R 16/0207

(57) ABSTRACT

A wire harness assembly includes: a wire harness including an electric wire and a connector electrically connected to an end of the electric wire; and an assembly member in which the wire harness is arranged. The assembly member includes: a base; and a cover attached to the base via a bonding portion. The bonding portion includes an outer bonding portion arranged along an outer edge of the assembly member. A non-bonding region in which the bonding portion is not arranged is provided between the base and the cover.

### CROSS-REFERENCE TO RELATED APPLICATIONS

The present application is based on and claims the benefit of priority from the prior Japanese Patent Application No. 2023-215083, filed on Dec. 20, 2023, the entire contents of which are incorporated by reference herein.

### TECHNICAL FIELD

The disclosure relates to a wire harness assembly.

### BACKGROUND

JP 2015-67071 A describes a wire harness assembly including a wire harness and an assembly sheet as an assembly member in which the wire harness is arranged, the wire harness including an electric wire and a connector electrically connected to an end of the electric wire. In the wire harness assembly, the assembly sheet includes a soundproofing/heat insulating sheet as a base and a bonding sheet as a cover. The wire harness is arranged between the soundproofing/heat insulating sheet and the bonding sheet. In the wire harness assembly, an adhesive is applied onto an entire surface of the bonding sheet to form a bonding portion, and the bonding sheet is attached to the soundproofing/heat insulating sheet via the bonding portion.

### SUMMARY

In the wire harness assembly described above, since the bonding portion for attaching the cover to the base is provided on the entire surface of the assembly member, a large amount of adhesive is used for the bonding portion, incurring a high cost.

The disclosure is directed to a wire harness assembly that can be manufactured at low cost.

A wire harness assembly in accordance with some embodiments includes: a wire harness including an electric wire and a connector electrically connected to an end of the electric wire; and an assembly member in which the wire harness is arranged. The assembly member includes: a base; and a cover attached to the base via a bonding portion. The bonding portion includes an outer bonding portion arranged along an outer edge of the assembly member. A non-bonding region in which the bonding portion is not arranged is provided between the base and the cover.

According to the above-described configuration, the cost of the wire harness assembly can be reduced.

### BRIEF DESCRIPTION OF THE DRAWINGS

FIG. 1 is a perspective view of a wire harness assembly according to an embodiment.

FIG. 2 is a top view of the wire harness assembly according to the present embodiment.

FIG. 3 is a perspective view when a masking sheet is arranged on a base of the wire harness assembly according to the present embodiment.

FIG. 4 is a perspective view when an adhesive is sprayed onto the masking sheet of the wire harness assembly according to the present embodiment.

FIG. 5 is a perspective view when the adhesive is applied onto the masking sheet of the wire harness assembly according to the present embodiment.

FIG. 6 is a perspective view when the masking sheet is removed from the base of the wire harness assembly according to the present embodiment.

### DETAILED DESCRIPTION

Hereinafter, a wire harness assembly 1 according to an embodiment will be described in detail with reference to the drawings. Note that dimensional ratios in the drawings are exaggerated for convenience of explanation, and may be different from actual ratios.

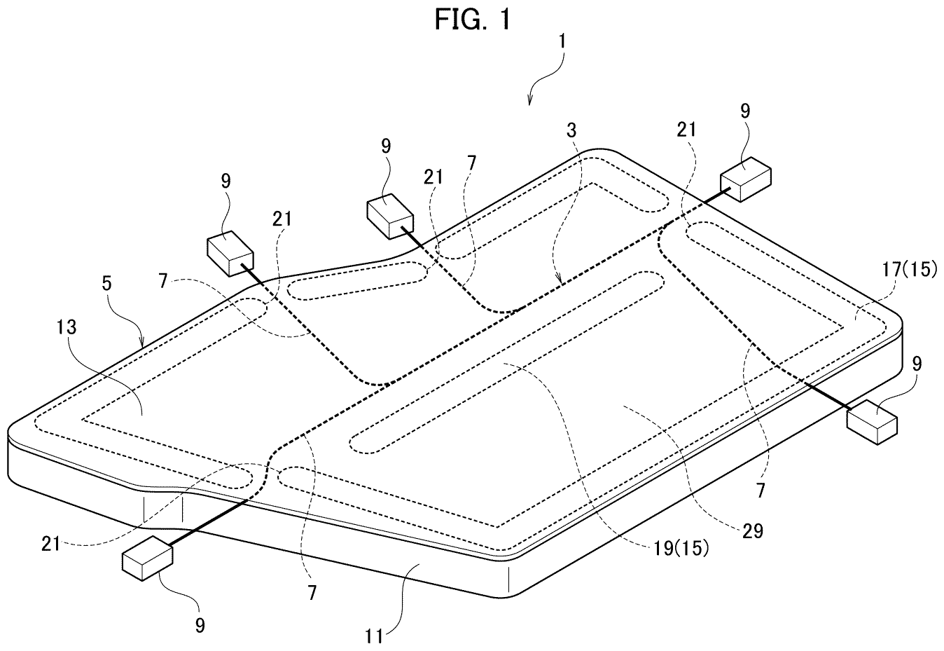

As illustrated in FIG. 1, the wire harness assembly 1 according to the present embodiment is applied to, for example, a wire harness 3 that electrically connects electrical components (not illustrated), e.g., a power supply mounted on a vehicle and a device or a device and a device. The wire harness 3 is arranged in a predetermined shape inside an assembly member 5 integrally assembled therewith. The wire harness assembly 1 is assembled to a target member (not illustrated), e.g., a door trim of a vehicle.

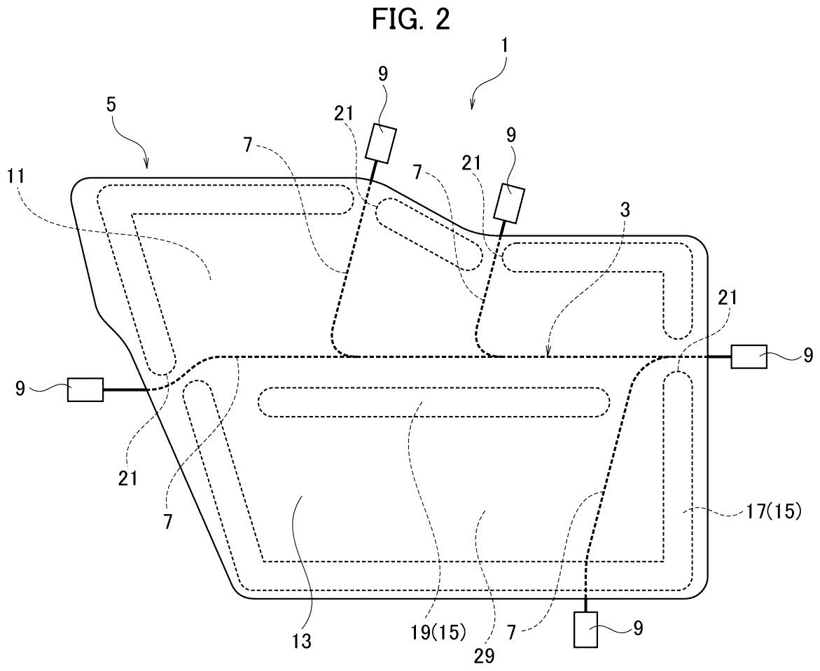

As illustrated in FIGS. 1 and 2, the wire harness assembly 1 includes a wire harness 3 and an assembly member 5.

As illustrated in FIGS. 1 and 2, the wire harness 3 includes an electric wire 7 and a connector 9.

The electric wire 7 includes, for example, a sheathed electric wire in which an outer periphery of a core wire made of a conductive material is sheathed with an insulating sheath, and a plurality of (four in the present embodiment) electric wires 7 are used. The electric wire 7 may be a flat cable in which outer peripheries of a plurality of core wires are sheathed with an insulating sheath in a state where the plurality of core wires are arranged in parallel. The plurality of electric wires 7 are arranged in such a manner that ends on both sides thereof are exposed from the assembly member 5. The plurality of electric wires 7 are arranged in such a manner that the ends on one end sides are collected at one location, and the ends on the other end sides are branched.

The connector 9 includes, for example, a housing (not illustrated) made of an insulating material such as a synthetic resin, and a terminal (not illustrated) made of a conductive material. The housing can be fitted to, for example, a mating housing (not illustrated) of a mating connector (not illustrated) electrically connected to an electric component mounted on the vehicle. The terminal is electrically connected to the end of the electric wire 7, and is accommodated in the housing. The terminal is electrically connected to a mating terminal (not illustrated) accommodated in the mating housing by fitting the housing to the mating housing. A plurality of (five in the present embodiment) connectors 9 are used to correspond to the ends of the plurality of electric wires 7 exposed from the assembly member 5.

As illustrated in FIGS. 1 and 2, the assembly member 5 includes a base 11 and a cover 13.

The base 11 is made of, for example, a foam of urethane or the like, or a nonwoven fabric of polypropylene fibers, polyethylene terephthalate fibers, polyester-based fibers, or the like, and has soundproofing and heat insulating properties. The base 11 is formed in a sheet shape with a size set so that the base 11 is arranged within the range of the target member, and is assembled to the target member by a fixing means (not illustrated) such as press fitting. On one surface side of the base 11, the plurality of (four in the present embodiment) electric wires 7 of the wire harness 3 are arranged in a predetermined shape. The ends of the plurality of electric wires 7, each of the electric wires 7 being arranged on the base 11, are exposed from an outer edge of the base 11 with a predetermined length, and the connectors 9 are arranged outside the base 11.

The cover 13 is made of, for example, a film of vinyl chloride, polyethylene, or the like, or a closed-cell foam or an open-cell foam of polyethylene, polypropylene, polystyrene, elastomer, or the like, and has soundproofing and heat insulating properties. The cover 13 is formed in a sheet shape with a size set to be equal to that of the base 11 so that the cover 13 is arranged within the range of the target member, and a thickness set to be smaller than that of the base 11. A bonding portion 15 formed of an adhesive is provided on a surface of the cover 13 facing the base 11. The cover 13 is attached to one surface side of the base 11 by the bonding portion 15 in such a manner that the plurality of electric wires 7 are sandwiched between the cover 13 and the base 11. In a state where the cover 13 is attached to the base 11, the plurality of electric wires 7 arranged in a predetermined shape are held between the base 11 and the cover 13. Therefore, the assembly member 5 can protect the electric wire 7 of the wire harness 3, and maintain the arrangement shape of the electric wire 7.

The connector 9 exposed from the assembly member 5 is fitted to a mating connector in a state where the wire harness assembly 1 is assembled to the target member. At this time, since the electric wire 7 is exposed from the outer edge of the assembly member 5 with a predetermined length, the connector 9 can freely move, making it easy to fit the connector 9 to a mating connector. By fitting the connector 9 to the mating connector, electrical components are electrically connected to each other.

Here, in a conventional wire harness assembly, a bonding portion for attaching a base and a cover is provided on an entire surface of an assembly member. Therefore, a large amount of adhesive is used for the bonding portion, incurring a high cost.

On the other hand, in the present embodiment, the bonding portion 15 includes an outer bonding portion 17 and an inner bonding portion 19. A non-bonding region 29 in which the bonding portion 15 is not arranged is provided between the base 11 and the cover 13.

The outer bonding portion 17 is arranged along an outer edge of the assembly member 5 between the base 11 and the cover 13 of the assembly member 5. The outer bonding portion 17 bonds outer edges of the base 11 and the cover 13 to each other to attach the base 11 and the cover 13 integrally. By providing the outer bonding portion 17 on the outer edge of the assembly member 5, the base 11 and the cover 13 can be integrated, and the non-bonding region 29 where the bonding portion 15 is not arranged can be formed inside the outer edge of the assembly member 5. Therefore, it is possible to reduce the adhesive usage amount as much as the non-bonding region 29 inside the outer edge of the assembly member 5.

The outer bonding portion 17 has a division portion 21 divided to avoid the electric wire 7. In the present embodiment, four division portions 21 are provided in the outer bonding portion 17. Since the electric wire 7 arranged in the division portion 21 is not bonded to the outer bonding portion 17, the electric wire 7 can freely move in the division portion 21. Therefore, the connector 9 provided at the end of the electric wire 7 can freely move, making it easy to fit the connector 9. In addition, by providing the division portion 21 in the outer bonding portion 17, the division portion 21 can be used as a guide for arranging the electric wire 7, and assemblability can be improved. On the other hand, since the electric wire 7 arranged in the outer bonding portion 17 is bonded to the outer bonding portion 17, the movement of the electric wire 7 is restricted. Therefore, for example, when the movement of the connector 9 is limited due to interference with peripheral members or the like, the connector 9 can be positioned by regulating the movement of the connector 9 provided at the end of the electric wire 7. In the present embodiment, four division portions 21 are provided in the outer bonding portion 17, but the present invention is not limited thereto, and the number of division portions 21 and the locations of the division portions 21 may be set in consideration of limitations of peripheral members, etc.

The inner bonding portion 19 is arranged inside the outer edge of the assembly member 5 between the base 11 and the cover 13 of the assembly member 5. The inner bonding portion 19 is arranged at a position avoiding the electric wire 7 of the wire harness 3. A portion other than the inner bonding portion 19 between the base 11 and the cover 13 is a non-bonding region 29 where the bonding portion 15 is not arranged. The inner bonding portion 19 bonds portions inside the outer edges of the base 11 and the cover 13 to attach the base 11 and the cover 13 integrally. By arranging the inner bonding portion 19 at a position avoiding the electric wire 7 inside the outer edge of the assembly member 5, it is possible to stably integrate the base 11 and the cover 13 while suppressing a reduction in the non-bonding region 29 and minimizing the adhesive usage amount. In addition, by arranging the inner bonding portion 19 at a position avoiding the electric wire 7, the inner bonding portion 19 can be used as a guide for arranging the electric wire 7, and assemblability can be improved.

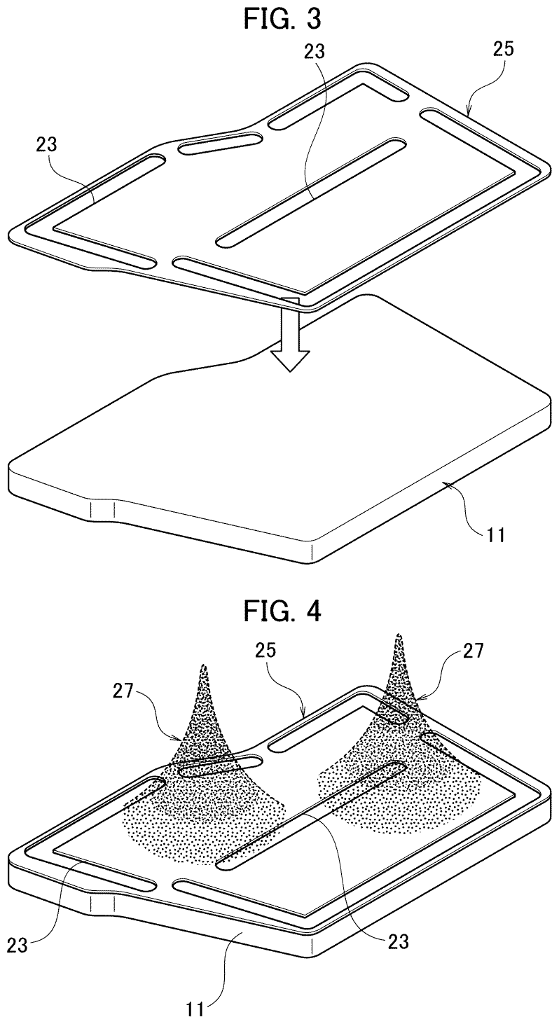

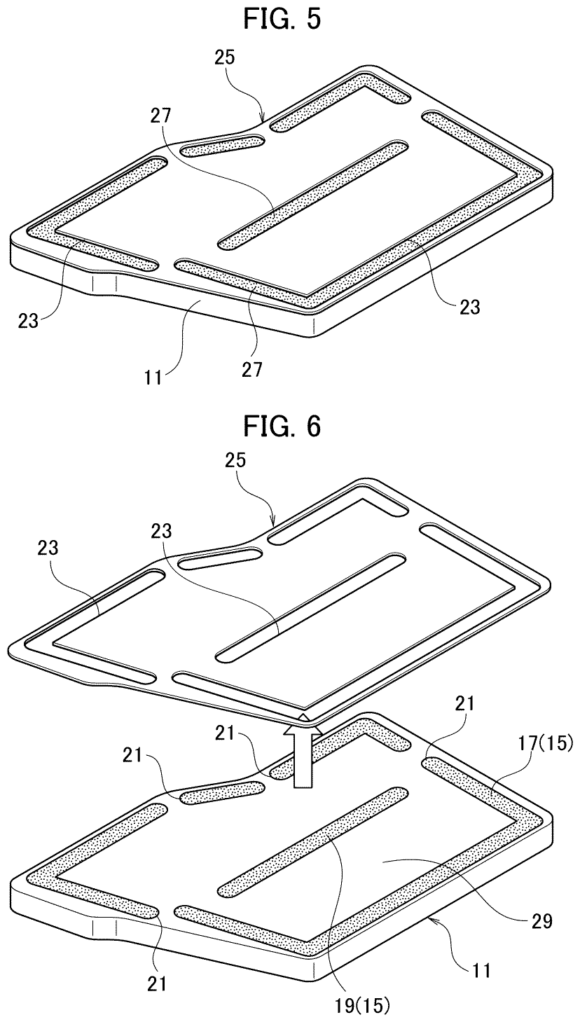

An example of a method of forming the bonding portion 15 will be described with reference to FIGS. 3 to 6. In the following description, it is assumed that the bonding portion 15 is formed on the base 11, but the bonding portion 15 may be formed on the cover 13. First, as illustrated in FIG. 3, a masking sheet 25 in which through holes 23 are formed at positions where an outer bonding portion 17 and an inner bonding portion 19 are to be provided as the bonding portion 15 is arranged on one surface side of base 11. Next, as illustrated in FIG. 4, an adhesive 27 is sprayed onto the masking sheet 25. As illustrated in FIG. 5, the adhesive 27 is applied into the through holes 23 of the masking sheet 25 onto which the adhesive 27 is sprayed. Then, as illustrated in FIG. 6, by removing the masking sheet 25 from the base 11, an outer bonding portion 17 and an inner bonding portion 19 as the bonding portion 15, and a non-bonding region 29 are formed on the base 11.

The wire harness assembly 1 according to the present embodiment includes a wire harness 3 including a electric wire 7 and a connector 9 electrically connected to a end of the electric wire 7, and an assembly member 5 in which the wire harness 3 is arranged. The assembly member 5 includes a base 11, and a cover 13 attached to the base 11 via a bonding portion 15. The bonding portion 15 includes an outer bonding portion 17 arranged along an outer edge of the assembly member 5. A non-bonding region 29 in which the bonding portion 15 is not arranged is provided between the base 11 and the cover 13.

By providing the outer bonding portion 17 in the bonding portion 15, the base 11 and the cover 13 can be integrated, and the non-bonding region 29 where the bonding portion 15 is not arranged can be formed inside the outer edge of the assembly member 5. Therefore, it is possible to reduce the adhesive usage amount as much as the non-bonding region 29 inside the outer edge of the assembly member 5.

As a result, the cost of the wire harness assembly 1 can be reduced.

The bonding portion 15 includes an inner bonding portion 19 arranged at a position avoiding the electric wire 7 inside the outer edge of the assembly member 5.

By providing the inner bonding portion 19 in the bonding portion 15, it is possible to stably integrate the base 11 and the cover 13 while suppressing a reduction in the non-bonding region 29 and minimizing the adhesive usage amount. In addition, the inner bonding portion 19 can be used as a guide for arranging the electric wire 7, and assemblability can be improved.

The outer bonding portion 17 has a division portion 21 divided to avoid the electric wire 7.

Since the electric wire 7 arranged in the division portion 21 is not bonded to the outer bonding portion 17, the electric wire 7 can freely move in the division portion 21. Therefore, the connector 9 provided at the end of the electric wire 7 can freely move, making it easy to fit the connector 9. In addition, the division portion 21 can be used as a guide for arranging the electric wire 7, and assemblability can be improved.

In the above-described embodiment, the number of the electric wires 7 in the wire harness 3 is four, but the present invention is not limited thereto, and the number of the electric wires 7 may be three or less or may be five or more. In the above-described embodiments, one end sides of the plurality of electric wires 7 are collected into one connector 9, but the present invention is not limited thereto, and the connector 9 may be provided on each of one end sides of the plurality of electric wires 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wire harness assembly comprising:
a wire harness including an electric wire and a connector electrically connected to an end of the electric wire; and
an assembly member in which the wire harness is arranged, wherein
the assembly member includes:
a base; and
a cover attached to the base via a bonding portion,
the bonding portion includes an outer bonding portion arranged along an outer edge of the assembly member, and
a non-bonding region in which the bonding portion is not arranged is provided between the base and the cover.

2. The wire harness assembly according to claim 1, wherein the bonding portion includes an inner bonding portion arranged at a position avoiding the electric wire inside the outer edge of the assembly member.

3. The wire harness assembly according to claim 1, wherein the outer bonding portion includes a division portion divided to avoid the electric wire.
